(19) United States
(12) Patent Application Publication
(10) Pub. No.: US 2025/0153137 A1
(43) Pub. Date: May 15, 2025

(54) WATER-ABSORBENT MATERIAL, WATER RECOVERY DEVICE, AND METHOD FOR RECOVERING WATER

(71) Applicant: NITTO DENKO CORPORATION, Ibaraki-shi, Osaka (JP)

(72) Inventors: Jumpei KUNO, Ibaraki-shi, Osaka (JP); Daisuke MATSUKUMA, Ibaraki-shi, Osaka (JP); Yasutaka KAWASAKI, Ibaraki-shi, Osaka (JP)

(21) Appl. No.: 18/838,494

(22) PCT Filed: Dec. 13, 2022
(86) PCT No.: PCT/JP2022/045948

§ 371 Date: Aug. 14, 2024

(30) Foreign Application Priority Data
Feb. 28, 2022 (JP) 2022-029072

(51) Int. Cl. B01J 20/26; B01D 53/26

(52) U.S. Cl. CPC B01J 20/26; B01D 53/263; B01D 2252/504; B01D 2257/80; B01J 2220/46

(57) ABSTRACT

The present invention provides a water-absorbent material suitable for taking out liquid water from a gas or a liquid that contains water, in particular, the atmospheric air. The water-absorbent material of the present invention includes: a compound A of which affinity for water reversibly changes due to stimulation from outside; and a compound B having hygroscopicity. At least one selected from the group consisting of the compound A and the compound B is a low-molecular-weight compound. A method for recovering water of the present invention incudes: bringing the above water-absorbent material into contact with a gas or a liquid that contains water, to cause the water-absorbent material to take in water; and applying stimulation from outside to the water-absorbent material, to take out liquid water from the water-absorbent material.

### TECHNICAL FIELD

The present invention relates to a water-absorbent material, a water recovery device, and a method for recovering water.

### BACKGROUND ART

In recent years, in association with climate change and population increase, water (fresh water) that is used as domestic water, industrial water, agricultural water, and the like is becoming scarce. In order to cope water shortage, if the amount of water intake from rivers is increased, river depletion may be caused, and if the amount of water intake from underground water is increased, ground subsidence may be caused. Further, when seawater is desalinated, it is necessary to discard a large amount of salt.

Meanwhile, in the atmospheric air, water in an amount of 6 to 7 times the total amount of water stored in rivers on the Earth is present as gas. Therefore, taking out liquid water from the atmospheric air may lead to a possibility that the water can be used as a new water resource. This water resource does not involve the problems such as river depletion, ground subsidence, salt discard, and the like described above, and thus is important also from the viewpoint of reducing the environmental load.

As an example of a technology of taking out liquid water from the atmospheric air, a water recovery device that rapidly cools the atmospheric air to condense water vapor is known.

### CITATION LIST

### Patent Literature

Patent Literature 1: WO2016/068129

### SUMMARY OF INVENTION

### Technical Problem

In the water recovery device that rapidly cools the atmospheric air to condense water vapor, the water recovery performance under a low temperature and low humidity environment largely decreases, and thus, is not suitable for use in dry regions or cold regions. Therefore, a new technology for taking out liquid water from a gas or a liquid that contains water, in particular, the atmospheric air, is required.

Therefore, the present invention provides a water-absorbent material suitable for taking out liquid water from a gas or a liquid that contains water, in particular, the atmospheric air.

### Solution to Problem

Studies by the present inventors show that there is a possibility that a moisture absorber (e.g., Patent Literature 1) included in a dehumidifier can be used for a water recovery device for taking out liquid water from the atmospheric air. Based on this finding, the present inventors advanced studies, and completed the present invention.

The present invention provides
a water-absorbent material including:
a compound A of which affinity for water reversibly changes due to stimulation from outside; and
a compound B having hygroscopicity, wherein
at least one selected from the group consisting of the compound A and the compound B is a low-molecular-weight compound.

Further, the present invention provides
a water recovery device including the above water-absorbent material.

Further, the present invention provides a method for recovering water, the method including:
bringing the above water-absorbent material into contact with a gas or a liquid that contains water, to cause the water-absorbent material to take in water; and
applying stimulation from outside to the water-absorbent material, to take out liquid water from the water-absorbent material.

### Advantageous Effects of Invention

According to the present invention, it is possible to provide a water-absorbent material suitable for taking out liquid water from a gas or a liquid that contains water, in particular, the atmospheric air.

### DESCRIPTION OF EMBODIMENTS

A water-absorbent material according to a first aspect of the present invention includes:
a compound A of which affinity for water reversibly changes due to stimulation from outside; and
a compound B having hygroscopicity, wherein
at least one selected from the group consisting of the compound A and the compound B is a low-molecular-weight compound.

In a second aspect of the present invention, for example, in the water-absorbent material according to the first aspect, the compound A has a molecular weight of 1000 or less.

In a third aspect of the present invention, for example, in the water-absorbent material according to the first or second aspect, the stimulation is light stimulation.

In a fourth aspect of the present invention, for example, in the water-absorbent material according to any one of the first to third aspects, the compound A exhibits hydrophilicity due to application of ultraviolet light thereto, and exhibits hydrophobicity due to application of visible light thereto.

In a fifth aspect of the present invention, for example, in the water-absorbent material according to any one of the first to fourth aspects, the compound A is represented by Formula (1) or Formula (2) below:

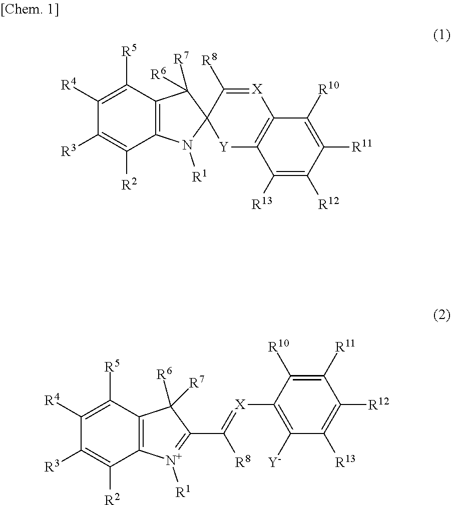

in the Formula (1) and the Formula (2), X is represented by C—R⁹, N, or S, Y is represented by O or S, R¹ is an optional substituent group, and R² to R¹³ are independent of each other and are each a hydrogen atom or an optional substituent group.

In a sixth aspect of the present invention, for example, in the water-absorbent material according to any one of the first to fifth aspects, the compound B has a molecular weight of 1000 or less.

In a seventh aspect of the present invention, for example, in the water-absorbent material according to any one of the first to sixth aspects, the compound B is an organic compound.

In an eighth aspect of the present invention, for example, in the water-absorbent material according to the seventh aspect, the compound B is at least one selected from the group consisting of glycerin, and polyglycerin having a molecular weight of 1000 or less.

In a ninth aspect of the present invention, for example, in the water-absorbent material according to any one of the first to sixth aspects, the compound B is an inorganic compound.

In a tenth aspect of the present invention, for example, in the water-absorbent material according to the ninth aspect, the compound B is calcium chloride.

In an 11th aspect of the present invention, for example, the water-absorbent material according to any one of the first to tenth aspects further includes a matrix, and the compound A and the compound B are dispersed in the matrix.

In a 12th aspect of the present invention, for example, in the water-absorbent material according to the 11th aspect, the matrix includes a hydrophilic polymer.

A water recovery device according to a 13th aspect of the present invention includes the water-absorbent material according to any one of the first to 12th aspects.

A method for recovering water according to a 14th aspect of the present invention includes:
bringing the water-absorbent material according to any one of the first to 12th aspects into contact with a gas or a liquid that contains water, to cause the water-absorbent material to take in water; and
applying stimulation from outside to the water-absorbent material, to take out liquid water from the water-absorbent material.

Hereinafter, details of the present invention will be described, but the following description is not intended to limit the present invention to specific embodiments.

### [Embodiment of Water-Absorbent Material]

A water-absorbent material of the present embodiment includes: a compound A of which affinity for water reversibly changes due to stimulation from outside; and a compound B having hygroscopicity. In the water-absorbent material, at least one selected from the group consisting of the compound A and the compound B is a low-molecular-weight compound. As an example, both of the compound A and the compound B may be a low-molecular-weight compound. In the present description, the low-molecular-weight compound means a compound having a molecular weight of 1000 or less, for example. In the present description, a polymer (oligomer) having a molecular weight of 1000 or less is also regarded as a low-molecular-weight compound. In the present description, “water-absorbent material” means a material that can, while being in a dry state, take in water by coming into contact with a gas or a liquid that contains water. That is, “water-absorbent material” can function also as a moisture-absorbent material that can, while being in a dry state, take in water in a gas.

The water-absorbent material may further include a matrix, and the compound A and the compound B may be dispersed in the matrix. In other words, the compound A and the compound B may be embedded in the matrix.

### (Compound A)

As described above, in the compound A, the affinity for water reversibly changes due to stimulation from outside. As an example, the compound A is a compound in which a state of exhibiting hydrophilicity and a state of exhibiting hydrophobicity are switched due to stimulation from outside.

“The compound A exhibits hydrophilicity” means that the compound A has an ionized functional group, for example. Examples of the ionized functional group include: cation groups such as a quaternary ammonium cation group; anion groups such as a hydroxy anion group and a thiolate anion group; and the like. The compound A may be a betaine compound containing both a cation group and an anion group, in a state of exhibiting hydrophilicity. “The compound A exhibits hydrophobicity” means that the compound A does not have an ionized functional group, for example. Thus, the compound A is a compound in which the presence or absence of an ionized functional group changes due to stimulation from outside, for example. In the compound A, change in the molecular skeleton may be caused together with change in the presence or absence of an ionized functional group. Specific examples of the change in the molecular skeleton include ring opening of a ring structure included in the compound A, and the like.

Preferably, the stimulation from outside is light stimulation. As an example, preferably, the compound A exhibits hydrophilicity due to application of ultraviolet light thereto, and exhibits hydrophobicity due to application of visible light thereto. In the present description, the ultraviolet light means light in a wavelength range of 100 nm or more and 400 nm or less, and preferably is light in a wavelength range including 365 nm. The visible light means light in a wavelength range of more than 400 nm and 750 nm or less, and preferably is light (green light) in a wavelength range of 490 to 550 nm. However, the stimulation from outside may be thermal stimulation, stimulation due to change in pH, stimulation due to change in an electric field, stimulation due to stress, or the like.

The compound A is represented by Formula (1) or Formula (2) below, for example. In the present description, the compound A represented by Formula (1) may be referred to as a spiropyran a1, and the compound A represented by Formula (2) may be referred to as a merocyanine a2. Normally, the spiropyran a1 exhibits hydrophobicity and the merocyanine a2 exhibits hydrophilicity. The spiropyran a1 changes into the merocyanine a2 due to application of ultraviolet light thereto. The merocyanine a2 changes into the spiropyran a1 due to application of visible light thereto.

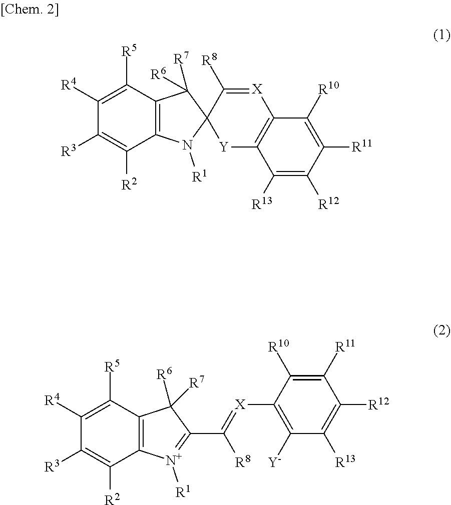

In Formula (1) and Formula (2), X is represented by C—R⁹, N, or S, and preferably represented by C—R⁹. Y is represented by O or S, and preferably represented by O. The compound A is typically represented by Formula (3) or Formula (4) below.

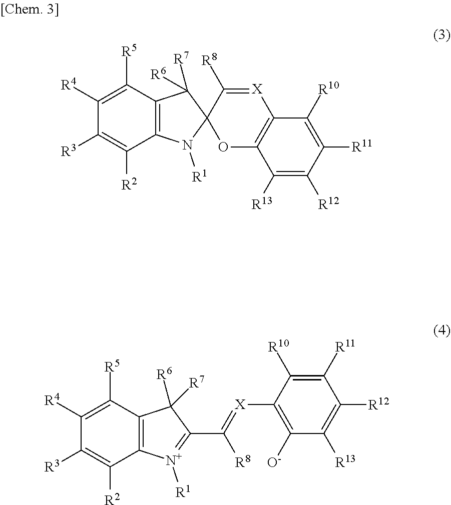

In Formula (1) to Formula (4), R¹ is an optional substituent group, R² to R¹³ is independent of each other and is a hydrogen atom or an optional substituent group. The optional substituent group is not limited in particular, and examples thereof include a hydrocarbon group, a halogen group, a nitro group, a hydroxy group, an alkoxy group, a carboxyl group, an amide group, and an acyl group. The hydrocarbon group may be linear, branched, or ring-shaped. The number of carbon atoms of the hydrocarbon group is not limited in particular, and is, for example, 1 to 10 and preferably 1 to 3. The hydrocarbon group is, for example, an alkyl group such as methyl group, ethyl group, or propyl group, and is preferably methyl group. The hydrocarbon group may further have a substituent group such as a halogen group. Examples of the halogen group include fluoro group, chloro group, and the like. Examples of the alkyl group included in the alkoxy group include those described above. A specific example of the alkoxy group is methoxy group.

A specific example of the spiropyran a1 is Formula (a1-1) below.

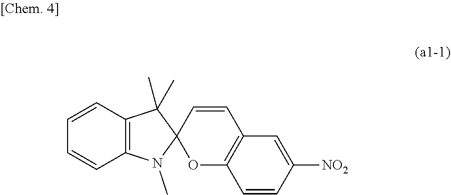 [SMILES: CN1c2ccccc2C(C)(C)C12C=Cc1cc([N+](=O)[O-])ccc1O2]

A specific example of the merocyanine a2 is Formula (a2-1) below.

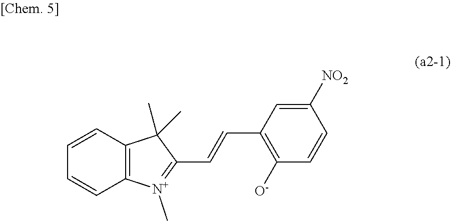 [SMILES: C[N+]1=C(/C=C/c2cc([N+](=O)[O-])ccc2[O-])C(C)(C)c2ccccc21]

The compound A may be another compound other than the spiropyran a1 and the merocyanine a2. Examples of the other compound include rhodamines, azobenzene derivatives, and the like.

As described above, preferably, the compound A is a low-molecular-weight compound. The molecular weight of the compound A is, for example, 1000 or less, and may be 900 or less, 800 or less, 700 or less, 600 or less, 500 or less, or further 400 or less. The lower limit value of the molecular weight of the compound A is not limited in particular, and is 100, for example. In the water-absorbent material, when the compound B is a low-molecular-weight compound, the compound A may be a high-molecular-weight compound.

The water-absorbent material of the present embodiment may contain the compound A of one type, or may contain the compound A of two or more types. The content of the compound A in the water-absorbent material is not limited in particular, and is, for example, 0.01 wt % or more, and may be 0.1 wt % or more, 0.5 wt % or more, 1.0 wt % or more, 1.5 wt % or more, 2.0 wt % or more, or further 3.0 wt % or more. The higher the content of the compound A is, the more easily liquid water tends to be taken out from the water-absorbent material. The upper limit value of the content of the compound A is not limited in particular, and is 10 wt %, for example. In the present description, unless mentioned in particular, “the content in the water-absorbent material” means the content based on the water-absorbent material in a dry state. “Dry state” means that the content of water in the water-absorbent material is 0.1 wt % or less. The water-absorbent material in the dry state is obtained by freeze-drying the water-absorbent material, for example.

### (Compound B)

As described above, the compound B has hygroscopicity. That the compound B has hygroscopicity means that at least one requirement selected from the group consisting of Requirements (i) to (iii) below is satisfied.
(i) When the compound B in the dry state is placed in an environment of 25±2.5° C. and 20% RH for 48 hours, the weight of water taken in by 1 g of the compound B is 80 mg or more.
(ii) When the compound B in the dry state is placed in an environment of 25±2.5° C. and 50% RH for 48 hours, the weight of water taken in by 1 g of the compound B is 200 mg or more.
(iii) When the compound B in the dry state is placed in an environment of 25±2.5° C. and 90% RH for 48 hours, the weight of water taken in by 1 g of the compound B is 300 mg or more.

In a preferable embodiment of the present invention, the compound B is an organic compound. The compound B as the organic compound may be solid or may be liquid at 25° C. The compound B has an oxygen-atom-containing functional group such as a hydroxyl group, a carboxyl group, or an ether group, a nitrogen-atom-containing functional group such as an amino group, or the like, for example. In the compound B, the number of the above functional groups is, for example, one or more, and may be two or more, or further three or more. The compound B may be composed only of an oxygen-atom-containing functional group, and an alkyl group. In the compound B, the oxygen-atom-containing functional group may form a salt with another cation.

Examples of the compound B include polyhydric alcohols, polyvalent carboxylic acids, and the like. The number of carbon atoms of the polyhydric alcohol is not limited in particular, and is, for example, 1 to 30, preferably 1 to 10 and more preferably 2 to 5. Examples of the polyhydric alcohol include dihydric alcohols such as ethylene glycol and propylene glycol, trihydric alcohols such as glycerin, and condensates of these. Examples of the condensate include polyethylene glycol such as diethylene glycol and triethylene glycol, polyglycerin, and the like. The compound B is preferably at least one selected from the group consisting of glycerin, and polyglycerin having a molecular weight of 1000 or less, and is more preferably glycerin.

A specific example of the polyvalent carboxylic acid is polyacrylic acid and a salt thereof. The compound B may be one obtained by crosslinking polyacrylic acid by a crosslinking agent. In other words, the compound B may have a crosslinked structure.

In another preferable embodiment of the present invention, the compound B is an inorganic compound. The compound B as the inorganic compound is solid at 25° C., for example. The compound B may be deliquescent. Examples of the compound B include chlorides such as calcium chloride and magnesium chloride, carbonates such as potassium carbonate, and the like. Preferably, the compound B is calcium chloride.

As described above, preferably, the compound B is a low-molecular-weight compound. The molecular weight of the compound B is, for example, 1000 or less, and may be 900 or less, 800 or less, 700 or less, 600 or less, 500 or less, 400 or less, 300 or less, 200 or less, or further 100 or less. The lower limit value of the molecular weight of the compound B is not limited in particular, and is 50, for example.

In the water-absorbent material, when the compound A is a low-molecular-weight compound, the compound B may be a high-molecular-weight compound (e.g., polyacrylic acid). In this case, the weight-average molecular weight of the compound B is not limited in particular, is, for example, more than 1000, and may be 5000 or more, 10000 or more, or further 50000 or more. The upper limit value of the weight-average molecular weight of the compound B is, for example, 5000000, and may be 1000000. The compound B as the high-molecular-weight compound can also function as the matrix described above. Therefore, when the compound B is a high-molecular-weight compound, the water-absorbent material need not necessarily additionally contain a material functioning as the matrix.

The water-absorbent material of the present embodiment may contain the compound B of one type, or may contain the compound B of two or more types. The content of the compound B in the water-absorbent material is not limited in particular, and is, for example, 30 wt % or more, and may be 40 wt % or more, 50 wt % or more, 60 wt % or more, 70 wt % or more, 80 wt % or more, or further 90 wt % or more. The higher the content of the compound B is, the more easily the water-absorbent material tends to take in water. The upper limit value of the content of the compound B is not limited in particular, and is 99 wt %, for example.

### (Matrix)

The matrix can, for example, hold the compound A and the compound B and inhibit the compound A and the compound B from being released from the water-absorbent material. Preferably, the matrix contains a material that can form a gel (hydrogel), e.g., a hydrophilic polymer, that contains water. Examples of the hydrophilic polymer include: polysaccharides such as tamarind seed gum, agarose, carboxymethyl cellulose, hyaluronic acid, and alginic acid, and salts thereof; and synthetic polymers such as polyvinyl alcohol (PVA), polymethacrylic acid, polyethylenimine, sodium polyethylenesulfonate, poly N-isopropyl acrylamide, and polyvinylpyridine. Preferably, the matrix contains tamarind seed gum as the hydrophilic polymer. The hydrophilic polymer may be one obtained by crosslinking the above-described polymer by a crosslinking agent. In other words, the hydrophilic polymer may have a crosslinked structure.

The weight-average molecular weight of the hydrophilic polymer is not limited in particular, and is, for example, more than 1000, and may be 5000 or more, 10000 or more, or further 50000 or more. The upper limit value of the weight-average molecular weight of the hydrophilic polymer is, for example, 5000000, and may be 1000000.

The matrix may contain the hydrophilic polymer of one type, or may contain the hydrophilic polymer of two or more types. The matrix may contain the hydrophilic polymer as a main component, and may be substantially composed only of the hydrophilic polymer. “Main component” means a component contained in the largest amount in terms of weight ratio in the matrix. However, the matrix may further contain another component other than the hydrophilic polymer.

The content of the matrix in the water-absorbent material of the present embodiment is not limited in particular, and is, for example, 50 wt % or less, and may be 40 wt % or less, 30 wt % or less, or further 20 wt % or less. The lower limit value of the content of the matrix is not limited in particular, and is 1 wt %, for example.

### (Other Components)

The water-absorbent material may further contain another component other than the compound A, the compound B, and the matrix. Examples of the other component include solvent components such as water and alcohol. As an example, as a result of the water-absorbent material containing water, the hydrophilic polymer in the matrix may form a hydrogel.

### (Water-Absorbent Material)

Examples of the shape of the water-absorbent material of the present embodiment are not limited in particular, and examples thereof include a film shape, a disk shape, a block shape, a particulate shape, and the like. In the present description, the particulate shape includes a spherical shape, an ellipsoid shape, a flake shape, a fiber shape, and the like. The water-absorbent material may have a porous structure.

### (Method for Producing Water-Absorbent Material)

The water-absorbent material of the present embodiment can be produced by the following method, for example. First, the compound A is mixed with a solvent as necessary, to prepare a solution S1. As the solvent for the solution S1, water or an alcohol such as ethanol can be used, for example. Preferably, in the solution S1, the compound A is in a state of exhibiting hydrophilicity. As an example, when the compound A is the spiropyran a1, it is preferable that ultraviolet light is applied to the solution S1 to change the compound A into the merocyanine a2 in advance.

Next, as necessary, the compound B or a precursor of the compound B is mixed with a solvent to prepare a solution S2. As the solvent for the solution S2, those described above with respect to the solution S1 can be used. A specific example of the precursor of the compound B is polyacrylic acid. When the compound B is a liquid, the compound B need not necessarily be mixed with the solvent. Further, as necessary, the material for the matrix is mixed with a solvent, to prepare a solution S3. As the solvent for the solution S3, those described above with respect to the solution S1 can be used.

Next, the prepared solutions S1 to S3 are mixed together. The order of mixing the solutions S1 to S3 is not limited in particular. However, in a case, for example, where the compound B is calcium chloride and the material for the matrix is alginic acid, the compound B may also function as a crosslinking agent for the material for the matrix. In this case, preferably, the solution S1 and the solution S3 are mixed together, and then, the solution S2 is further mixed thereto.

To a mixed solution S of the solutions S1 to S3, a crosslinking agent for crosslinking the precursor of the compound B or the material for the matrix may further be added. As an example, when polyacrylic acid is used as the precursor of the compound B, a polyfunctional epoxy compound such as ethylene glycol diglycidyl ether can be used as a crosslinking agent. When polyvinyl alcohol is used as the material for the matrix, a polyfunctional aldehyde compound such as glutaraldehyde can be used as a crosslinking agent. When the crosslinking agent is added to the mixed solution S, heat treatment may further be performed on the mixed solution S.

Next, the mixed solution S is dried, whereby the water-absorbent material can be produced. The method for drying the mixed solution S is not limited in particular, and can be performed by leaving the mixed solution S in a room temperature environment (e.g., in an environment of 25° C. and 20% RH). The drying time for the mixed solution S is not limited in particular, is, for example, 1 hour or more, and may be 5 hours or more. The water-absorbent material obtained by drying the mixed solution S may contain a solvent component derived from the mixed solution S.

### (Method for Recovering Water)

The method for recovering water of the present embodiment includes: bringing the above water-absorbent material into contact with a gas or a liquid that contains water, to cause the water-absorbent material to take in water; and applying stimulation from outside to the water-absorbent material, to take out liquid water from the water-absorbent material.

In the recovering method of the present embodiment, before the water-absorbent material is brought into contact with the above gas or liquid, pretreatment may be performed on the water-absorbent material. The pretreatment is performed by leaving the water-absorbent material in a room temperature environment (e.g., in an environment of 25° C. and 20% RH), for example. The time for the pretreatment is not limited in particular, is, for example, 1 hour or more, and may be 5 hours or more. In the pretreatment, stimulation from outside may be applied to the water-absorbent material so that the compound A changes into a state of exhibiting hydrophilicity.

In the recovering method of the present embodiment, for example, a gas or a liquid that contains water, preferably, a gas that contains water, is brought into contact with the water-absorbent material on which the pretreatment has been performed. Accordingly, the water-absorbent material can take in water from the gas or the liquid. The time for bringing the above gas or liquid into contact with the water-absorbent material is not limited in particular, and is 5 hours or more, for example. In the present description, that the water-absorbent material takes in water from a gas or a liquid may simply be referred to as “moisture absorption”.

The gas that contains water is typically the atmospheric air. The temperature of this gas is not limited in particular, and is, for example, 0° C. to 50° C. and preferably 10° C. to 30° C. The humidity of this gas is not limited in particular, and is, for example, 10% RH to 90% RH and preferably 30% RH to 80% RH. In the present embodiment, even when a low temperature and low humidity gas is used, the water-absorbent material tends to be able to sufficiently take in water contained in the gas.

The liquid that contains water is typically liquid water itself. The temperature of this liquid is not limited in particular, and is, for example, 0° C. to 50° C. and preferably 10° C. to 30° C.

The weight (moisture absorption amount) of the water taken in by the water-absorbent material as a result of coming into contact with the above gas or liquid can be calculated by Formula (I) below. In Formula (I), W0 is the weight (g) of the water-absorbent material in the dry state (e.g., freeze-dried water-absorbent material). W1 is the weight (g) of the water-absorbent material (the water-absorbent material having come into contact with the gas or liquid) after moisture absorption. W2 is the weight (g) of the water-absorbent material (the water-absorbent material before coming into contact with the gas or liquid) before moisture absorption.

Moisture absorption amount (mg/g)=(W1 (g)−W2 (g))×1000/W0 (g) (I)

The above moisture absorption amount is, for example, 1 mg/g or more, and may be 5 mg/g or more, 10 mg/g or more, 20 mg/g or more, 30 mg/g or more, or further 40 mg/g or more. The upper limit value of the moisture absorption amount is not limited in particular, and is, for example, 3000 mg/g and may be 2000 mg/g.

Next, stimulation is applied from outside to the water-absorbent material having absorbed moisture. Accordingly, the affinity of the compound A for water changes. For example, the compound A changes into a state of exhibiting hydrophobicity. As a result of the change in the affinity of the compound A for water, water present around the compound A seeps out, in a state of liquid, from the water-absorbent material. Accordingly, liquid water can be taken out from the water-absorbent material having absorbed moisture.

The stimulation that is applied to the water-absorbent material can be appropriately selected in accordance with the compound A. As an example, when the compound A contained in the water-absorbent material having absorbed moisture is the merocyanine a2, it is preferable to apply light stimulation (specifically, stimulation by visible light) to the water-absorbent material. Accordingly, the compound A changes into the spiropyran a1 having hydrophobicity, and liquid water can be taken out from the water-absorbent material.

In Patent Literature 1, mainly, a method for recovering water by applying thermal stimulation to a water-absorbent material is proposed. However, when thermal stimulation is applied to the water-absorbent material by heating the water-absorbent material, a part of water having seeped out from the water-absorbent material tends to volatilize. According to the method in which light stimulation is applied to the water-absorbent material, there is no need to heat the water-absorbent material, and thus, as compared with the method in which thermal stimulation is applied, volatilization of water can be inhibited, and water can be efficiently recovered.

The weight (recovery amount) of liquid water capable of being taken out from the water-absorbent material by applying stimulation to the water-absorbent material can be identified by the following method, for example. First, two water-absorbent materials having the same structure and composition with each other are prepared, and the water-absorbent materials are caused to absorb moisture under the same condition. Extra water attached to the surface of the water-absorbent materials having absorbed moisture is removed. One of the water-absorbent materials is placed on filter paper and stimulation is applied thereto from outside. The other of the water-absorbent materials is placed on filter paper and left without application of stimulation thereto. From the water-absorbent material with application of stimulation thereto, liquid water seeps out, and the water is absorbed in the filter paper. A change amount C1 (mg) of the weight of the filter paper on which the water-absorbent material without application of stimulation thereto is disposed, and a change amount C2 (mg) of the weight of the filter paper on which the water-absorbent material with application of stimulation thereto is disposed are identified. Based on the change amount C1, the change amount C2, and a weight W0 (g) of the water-absorbent material in the dry state, the recovery amount can be calculated by Formula (II) below.

Recovery amount (mg/g)=(C2 (mg)−C1 (mg))/W0 (g) (II)

The above recovery amount is, for example, 1 mg/g or more, and may be 5 mg/g or more, 10 mg/g or more, 20 mg/g or more, 30 mg/g or more, or further 40 mg/g or more. The upper limit value of the recovery amount is not limited in particular, and is 1000 mg/g, for example.

The recovering method of the present embodiment may further include performing a regeneration process on the water-absorbent material from which liquid water has been taken out. The regeneration process can be performed by applying stimulation from outside to the water-absorbent material so that the affinity of the compound A for water changes, for example. In the regeneration process, the compound A changes into a state of exhibiting hydrophilicity due to stimulation from outside, for example.

In the regeneration process, the stimulation to be applied to the water-absorbent material can be appropriately selected in accordance with the compound A. As an example, when the compound A contained in the water-absorbent material from which liquid water has been taken out is the spiropyran a1, it is preferable to apply light stimulation (specifically, stimulation by ultraviolet light) to the water-absorbent material. Accordingly, the compound A changes into the merocyanine a2 having hydrophilicity, and the water-absorbent material is regenerated. Through the regeneration of the water-absorbent material, the recovering method of the present embodiment can be repeatedly performed. When the compound A can spontaneously change from a state of exhibiting hydrophobicity into a state of exhibiting hydrophilicity, stimulation from outside is not necessarily required in the regeneration process. As an example, the spiropyran a1 may spontaneously change into the merocyanine a2, when left in the atmospheric air. However, in this case, the time necessary for the regeneration process tends to be long as compared with the case where stimulation from outside is applied to the water-absorbent material.

As described above, the water-absorbent material of the present embodiment is suitable for taking out liquid water from a gas or a liquid that contains water, in particular, the atmospheric air.

In the moisture absorber disclosed in Patent Literature 1, a stimulation responsive polymer and a hydrophilic polymer form an interpenetrating polymer network structure. In a case where the recovering method of the present embodiment is performed by using this moisture absorber, when the moisture absorber takes in water, or when liquid water is taken out from the moisture absorber, the position of the above polymer in the moisture absorber, the three-dimensional structure of the polymer, etc., tend to change. When the position of the polymer or the three-dimensional structure of the polymer changes, the volume of the moisture absorber changes. Thus, in the case of the moisture absorber of Patent Literature 1, while the above recovering method is carried out, the volume tends to change.

In the present embodiment, in the water-absorbent material, at least one selected from the group consisting of the compound A and the compound B is a low-molecular-weight compound. In this water-absorbent material, as compared with the moisture absorber of Patent Literature 1, the polymer of which the position or the three-dimensional structure changes while the above recovering method is carried out is less in amount. Therefore, in the water-absorbent material of the present embodiment, as compared with the moisture absorber of Patent Literature 1, change in the volume is inhibited. In particular, change in the volume of the water-absorbent material tends to be remarkably inhibited when the compound B is a low-molecular-weight compound.

The water-absorbent material may be used in a state of being attached to a substrate, in a water recovery device. Therefore, if the volume of the water-absorbent material changes while the above recovering method is carried out, the water-absorbent material may be detached from the substrate and fall. In the water-absorbent material of the present embodiment in which change in the volume is inhibited, falling of the water-absorbent material from the substrate can be sufficiently inhibited, and thus, the water-absorbent material of the present embodiment is suitable for industrial use.

### [Embodiment of Water Recovery Device]

The water recovery device of the present embodiment includes the water-absorbent material described above. The water recovery device further includes: a storage for storing the water-absorbent material; a stimulation application part for applying stimulation to the water-absorbent material; and a controller for controlling operation of the stimulation application part. To the storage, a gas or a liquid that contains water can be supplied. In the storage, the water-absorbent material may be attached to a substrate. As the stimulation application part, for example, a light source that applies ultraviolet light or visible light to the water-absorbent material can be used. The water recovery device may have a configuration that can apply sunlight to the water-absorbent material, instead of the stimulation application part or together with the stimulation application part. With the water recovery device, the above method for recovering water can be easily performed.

### EXAMPLES

Hereinafter, the present invention will further be described in detail with reference to Examples and Comparative Examples. However, the present invention is not limited thereto.

### Example 1

First, an aqueous solution that contained tamarind seed gum (manufactured by DSP Gokyo Food & Chemical Co., Ltd., GLYLOID 6C) as the material for the matrix, at a concentration of 1 wt % was prepared. 25.0 g of this aqueous solution and 1.0 g of glycerin (manufactured by Tokyo Chemical Industry Co., Ltd.) as the compound B were mixed together, and the mixed solution was stirred by a stirrer for 2 minutes.

Next, an ethanol solution containing a spiropyran represented by the above Formula (a1-1) (manufactured by Tokyo Chemical Industry Co., Ltd., 1,3,3-Trimethylindolino-6′-nitrobenzopyrylospiran) as the compound A, at a concentration of 0.25 wt % was prepared. To this ethanol solution, ultraviolet light was applied for 10 minutes. As the light source that applies ultraviolet light, a handy UV lamp (manufactured by AS ONE Corporation, SUV-16, wavelength: 365 nm, intensity: 2020 mW/cm²) was used. By applying ultraviolet light to the ethanol solution, the above spiropyran changed into a merocyanine represented by the above Formula (a2-1). Operation after the application of the ultraviolet light to the ethanol solution was performed in a light-shielded state, unless mentioned in particular.

Next, 4.0 g of the ethanol solution was added to the above mixed solution, and the resultant matter was stirred by a stirrer for 5 minutes. The obtained mixed solution was poured into a glass-made petri dish, and was air-dried for 3 hours. Further, the mixed solution was left to stand overnight in a thermo-hygrostat (manufactured by ESPEC CORP., SH-241) set under a condition of 25° C. and 20% RH, whereby the mixed solution was dried. Accordingly, a water-absorbent material of Example 1 being a hydrogel having a film shape was obtained.

### [Recovery Test]

With respect to the water-absorbent material of Example 1, a water recovery test was performed by the following method. Two water-absorbent materials having been dried overnight at 25° C. and 20% RH in advance were prepared. These water-absorbent materials were left to stand for 5 hours or more in an environment of 25° C. and 35 to 40% RH. Accordingly, the water-absorbent materials took in water contained in the gas present therearound. The weight (moisture absorption amount) of the water taken in by each water-absorbent material was calculated by using the above Formula (I).

Next, extra water attached to the surface of the water-absorbent material was removed. One of the water-absorbent materials was placed on filter paper and visible light was applied thereto. The other of the water-absorbent materials was placed on filter paper and was left without application of stimulation thereto. As the light source that applies visible light, a green LED light (manufactured by PELICAN, flashlight 2370, intensity: 358 Lm) was used. As a result of application of visible light to the water-absorbent material, the merocyanine changed into the spiropyran, and accordingly, liquid water seeped out from the water-absorbent material. The water having seeped out from the water-absorbent material was absorbed in the filter paper. The change amount C1 (mg) of the weight of the filter paper on which the water-absorbent material without application of stimulation thereto was disposed, and the change amount C2 (mg) of the weight of the filter paper on which the water-absorbent material with application of visible light thereto was disposed were identified, and the weight (recovery amount) of liquid water capable of being taken out from the water-absorbent material was calculated by using the above Formula (II).

### Examples 2 to 6

Water-absorbent materials of Examples 2 to 6 were obtained by the same method as in Example 1, except that the blending amounts of the compound A and the compound B were changed as shown in Table 1. Further, with respect to the water-absorbent materials of Examples 2 to 6, the water recovery test was performed by the same method as in Example 1.

### Example 7

A water-absorbent material of Example 7 was obtained by the same method as in Example 1, except that polyglycerin (manufactured by Sakamoto Yakuhin Kogyo Co., Ltd., polyglycerin #500, molecular weight: about 500) was used as the compound B. Further, with respect to the water-absorbent material of Example 7, the water recovery test was performed by the same method as in Example 1.

### Examples 8 to 9

The water recovery test was performed by the same method as in Example 1, except that humidity was changed as shown in Table 1 in the water recovery test (Examples 8 to 9).

### Example 10

First, agarose (manufactured by FUJIFILM Wako Pure Chemical Corporation, agarose 1600) as the material for the matrix was heated to be dissolved. To the liquid agarose, 3.0 g of glycerin (manufactured by Tokyo Chemical Industry Co., Ltd.) as the compound B was added. To the obtained mixed solution, 4.0 g of an ethanol solution prepared by the same method as in Example 1 was added, and the resultant matter was quickly stirred by using a spatula. The obtained mixed solution was poured into a glass-made petri dish. The mixed solution was left to stand overnight in a thermo-hygrostat (manufactured by ESPEC CORP., SH-241) set under a condition of 25° C. and 20% RH, whereby the mixed solution was dried. Accordingly, a water-absorbent material of Example 10 being a hydrogel having a disk shape was obtained. Further, with respect to the water-absorbent material of Example 10, the water recovery test was performed by the same method as in Example 1.

### Example 11

First, an aqueous solution that contained alginic acid (manufactured by FUJIFILM Wako Pure Chemical Corporation) as the material for the matrix was prepared. To this aqueous solution, 4.0 g of an ethanol solution prepared by the same method as in Example 1 was added, and the resultant matter was stirred by a stirrer for 5 minutes. The obtained mixed solution was dropped into an aqueous solution that contained calcium chloride (manufactured by FUJIFILM Wako Pure Chemical Corporation) as the compound B at a concentration of 5 wt %. At this time, a crosslinked structure of alginic acid via a calcium ion is formed and a gel having a spherical shape was generated. This gel was immersed for 1 hour in an aqueous solution of calcium chloride, and was sufficiently washed with distilled water. The gel was left to stand overnight in a thermo-hygrostat (manufactured by ESPEC CORP., SH-241) set under a condition of 25° C. and 20% RH, whereby the gel was dried. Accordingly, a water-absorbent material of Example 11 was obtained. Further, with respect to the water-absorbent material of Example 11, the water recovery test was performed by the same method as in Example 1.

### Example 12

First, an aqueous solution that contained polyvinyl alcohol (manufactured by FUJIFILM Wako Pure Chemical Corporation, average polymerization degree: 1,500 or more (1500 to 1800), saponification degree: 78 to 82 mol %) as the material for the matrix at a concentration of 5 wt % was prepared. This aqueous solution and 1.0 g of glycerin (manufactured by Tokyo Chemical Industry Co., Ltd.) as the compound B were mixed together, and the mixed solution was stirred by a stirrer for 2 minutes. To the obtained mixed solution, 4.0 g of an ethanol solution prepared by the same method as in Example 1 was added, and the resultant matter was stirred by a stirrer for 5 minutes.

Next, the obtained mixed solution was poured into a glass-made petri dish, and glutaraldehyde (manufactured by Merck) and hydrochloric acid were further added thereto, and the resultant matter was heated at 60° C. for 3 hours or more. At this time, crosslinking reaction of the polyvinyl alcohol proceeded due to the glutaraldehyde. Next, the mixed solution was left to stand overnight in a thermo-hygrostat (manufactured by ESPEC CORP., SH-241) set under a condition of 25° C. and 20% RH, whereby the mixed solution was dried. Accordingly, a water-absorbent material of Example 12 was obtained. Further, with respect to the water-absorbent material of Example 12, the water recovery test was performed by the same method as in Example 1.

### Example 13

First, an aqueous solution that contained sodium polyacrylate (manufactured by FUJIFILM Wako Pure Chemical Corporation, average polymerization degree: 30000 to 40000, molecular weight: about 2800000 to 3800000) as the precursor of the compound B was prepared. To this aqueous solution, 4.0 g of an ethanol solution prepared by the same method as in Example 1 was added, and the resultant matter was stirred by a stirrer for 5 minutes. To the obtained mixed solution, ethylene glycol diglycidyl ether was added, and the resultant matter was heated at 60° C. for 3 hours or more. At this time, crosslinking reaction of the sodium polyacrylate proceeded due to the ethylene glycol diglycidyl ether. Next, the mixed solution was left to stand overnight in a thermo-hygrostat (manufactured by ESPEC CORP., SH-241) set under a condition of 25° C. and 20% RH, whereby the mixed solution was dried. Accordingly, a water-absorbent material of Example 13 was obtained. Further, with respect to the water-absorbent material of Example 13, the water recovery test was performed by the same method as in Example 1.

### Comparative Example 1

A water-absorbent material of Comparative Example 1 was obtained by the same method as in Example 1, except that the ethanol solution containing the compound A was not used. Further, with respect to the water-absorbent material of Comparative Example 1, the water recovery test was performed by the same method as in Example 1. However, liquid water was not able to be taken out from the water-absorbent material of Comparative Example 1.

### Comparative Example 2

A water-absorbent material of Comparative Example 2 was obtained by the same method as in Example 5, except that the ethanol solution containing the compound A was not used. Further, with respect to the water-absorbent material of Comparative Example 2, the water recovery test was performed by the same method as in Example 1. However, liquid water was not able to be taken out from the water-absorbent material of Comparative Example 2.

### Comparative Example 3

A water-absorbent material of Comparative Example 3 was obtained by the same method as in Example 7, except that the ethanol solution containing the compound A was not used, and that the blending amount of polyglycerin was changed as shown in Table 2. Further, with respect to the water-absorbent material of Comparative Example 3, the water recovery test was performed by the same method as in Example 1. However, liquid water was not able to be taken out from the water-absorbent material of Comparative Example 3.

### Comparative Example 4

A water-absorbent material of Comparative Example 4 was obtained by the same method as in Example 11, except that the ethanol solution containing the compound A was not used. Further, with respect to the water-absorbent material of Comparative Example 4, the water recovery test was performed by the same method as in Example 1. However, liquid water was not able to be taken out from the water-absorbent material of Comparative Example 4.

### Comparative Example 5

A water-absorbent material of Comparative Example 5 was obtained by the same method as in Example 12, except that the ethanol solution containing the compound A was not used. Further, with respect to the water-absorbent material of Comparative Example 5, the water recovery test was performed by the same method as in Example 1. However, liquid water was not able to be taken out from the water-absorbent material of Comparative Example 5.

### Comparative Example 6

A water-absorbent material of Comparative Example 6 was obtained by the same method as in Example 13, except that the ethanol solution containing the compound A was not used. Further, with respect to the water-absorbent material of Comparative Example 6, the water recovery test was performed by the same method as in Example 1. However, liquid water was not able to be taken out from the water-absorbent material of Comparative Example 6.

TABLE 1

| | | | Example | Example | Example | Example | Example | Example | Example |
|---|---|---|---|---|---|---|---|---|---|
| | | | 1 | 2 | 3 | 4 | 5 | 6 | 7 |
| Blending | Compound | SP | 0.01 | 0.015 | 0.005 | 0.01 | 0.01 | 0.01 | 0.01 |
| amount | A | | | | | | | | |
| (g) | Matrix | TSP | 0.25 | 0.25 | 0.25 | 0.25 | 0.25 | 0.25 | 0.25 |
| | material | Agarose | | | | | | | |
| | | Alg/Ca | | | | | | | |
| | | PVA | | | | | | | |
| | Compound | Gly | 1 | 1 | 1 | 0.25 | 0.5 | 0.75 | |
| | B | PGly | | | | | | | 1 |
| | | PAA | | | | | | | |
| | | CaCl₂ | | | | | | | |
| | Solvent | Water | 25 | 25 | 25 | 25 | 25 | 25 | 25 |

| | | | | | | | |
|---|---|---|---|---|---|---|---|
| Humidity during moisture | 35 to 40 | 35 to 40 | 35 to 40 | 35 to 40 | 35 to 40 | 35 to 40 | 35 to 40 |
| absorption (% RH) | | | | | | | |
| Water recovery (*1) | ○ | ○ | ○ | ○ | ○ | ○ | ○ |
| Water recovery amount (mg/g) | 11.1 | 19.4 | 8.6 | 18.7 | 17.1 | 2.6 | 6.2 |

| | | | Example | Example | Example | Example | Example | Example |
|---|---|---|---|---|---|---|---|---|
| | | | 8 | 9 | 10 | 11 | 12 | 13 |
| Blending | Compound | SP | 0.01 | 0.01 | 0.01 | 0.01 | 0.01 | 0.01 |
| amount | A | | | | | | | |
| (g) | Matrix | TSP | 0.25 | 0.25 | | | | |
| | material | Agarose | | | 0.3 | | | |
| | | Alg/Ca | | | | 0.088 | | |
| | | PVA | | | | | 0.25 | |
| | Compound | Gly | 1 | 1 | 3 | | 1 | |
| | B | PGly | | | | | | |
| | | PAA | | | | | | 0.25 |
| | | CaCl₂ | | | | 0.5 | | |
| | Solvent | Water | 25 | 25 | 29.7 | 7.9 | 4.8 | 25 |

| | | | | | | |
|---|---|---|---|---|---|---|
| Humidity during moisture | 60 | 80 | 35 to 40 | 35 to 40 | 35 to 40 | 35 to 40 |
| absorption (% RH) | | | | | | |
| Water recovery (*1) | ○ | ○ | ○ | ○ | ○ | ○ |
| Water recovery amount (mg/g) | 14.9 | 45.3 | 13.3 | 30.5 | 4.1 | 5.5 |

(*1) ○: In the recovery test, liquid water was able to be taken out from the water-absorbent material. x: In the recovery test, liquid water was not able to be taken out from the water-absorbent material.

TABLE 2

| | | | Comparative | Comparative | Comparative | Comparative | Comparative | Comparative |
|---|---|---|---|---|---|---|---|---|
| | | | Example 1 | Example 2 | Example 3 | Example 4 | Example 5 | Example 6 |
| Blending | Compound | SP | | | | | | |
| amount | A | | | | | | | |
| (g) | Matrix | TSP | 0.25 | 0.25 | 0.25 | | | |
| | material | Agarose | | | | | | |
| | | Alg/Ca | | | | 0.088 | | |
| | | PVA | | | | | 0.25 | |
| | Compound | Gly | 1 | 0.5 | | | 1 | |
| | B | PGly | | | 0.5 | | | |
| | | PAA | | | | | | 0.25 |
| | | CaCl₂ | | | | 0.5 | | |
| | Solvent | Water | 25 | 5 | 5 | 7.9 | 4.8 | 25 |

| | | | | | | |
|---|---|---|---|---|---|---|
| Humidity during moisture | 35 to 40 | 35 to 40 | 35 to 40 | 35 to 40 | 35 to 40 | 35 to 40 |
| absorption (% RH) | | | | | | |
| Water recovery (*1) | x | x | x | x | x | x |
| Water recovery amount (mg/g) | — | — | — | — | — | — |

(*1) ○: In the recovery test, liquid water was able to be taken out from the water-absorbent material. x: In the recovery test, liquid water was not able to be taken out from the water-absorbent material.

Abbreviations in Tables 1 and 2 are as follows.
SP: 1,3,3-Trimethylindolino-6′-nitrobenzopyrylospiran (manufactured by Tokyo Chemical Industry Co., Ltd.)
TSP: tamarind seed gum (manufactured by DSP Gokyo Food & Chemical Co., Ltd., GLYLOID 6C)
Alg/Ca: crosslinked product of alginic acid via calcium ion
PVA: polyvinyl alcohol (manufactured by FUJIFILM Wako Pure Chemical Corporation, average polymerization degree: 1,500 or more (1500 to 1800), saponification degree: 78 to 82 mol %)
Gly: glycerin (manufactured by Tokyo Chemical Industry Co., Ltd.)
PGly: polyglycerin (manufactured by Sakamoto Yakuhin Kogyo Co., Ltd., polyglycerin #500, molecular weight: about 500)
PAA: sodium polyacrylate (manufactured by FUJIFILM Wako Pure Chemical Corporation, average polymerization degree: 30000 to 40000, molecular weight: about 2800000 to 3800000)
CaCl₂): calcium chloride (manufactured by FUJIFILM Wako Pure Chemical Corporation)

As seen from Tables 1 and 2, with the water-absorbent materials of Examples containing the compound A and the compound B, liquid water was able to be taken out from the gas that contained water, through the water recovery test. While the recovery test was being performed, with respect to the water-absorbent materials of Examples, change in the volume was not visually observed. Thus, in the water-absorbent materials of Examples, when water was taken in or when liquid water was taken out, change in the volume was sufficiently inhibited. It is inferred that the inhibition of change in the volume in the water-absorbent materials of Examples is due to the fact that the compound A and/or the compound B contained in the water-absorbent material is a low-molecular-weight compound.

### INDUSTRIAL APPLICABILITY

The water-absorbent material of the present embodiment is suitable for taking out liquid water from the atmospheric air, for example.

1. A water-absorbent material comprising:
a compound A of which affinity for water reversibly changes due to stimulation from outside; and
a compound B having hygroscopicity, wherein
at least one selected from the group consisting of the compound A and the compound B is a low-molecular-weight compound.

2. The water-absorbent material according to claim 1, wherein the compound A has a molecular weight of 1000 or less.

3. The water-absorbent material according to claim 1, wherein the stimulation is light stimulation.

4. The water-absorbent material according to claim 1, wherein the compound A exhibits hydrophilicity due to application of ultraviolet light thereto, and exhibits hydrophobicity due to application of visible light thereto.

5. The water-absorbent material according to claim 1, wherein
the compound A is represented by Formula (1) or Formula (2) below: 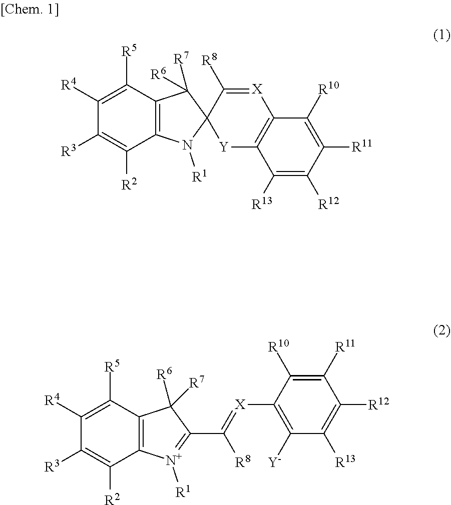
in the Formula (1) and the Formula (2), X is represented by C—R⁹, N, or S, Y is represented by O or S, R¹ is an optional substituent group, and R² to R¹³ are independent of each other and are each a hydrogen atom or an optional substituent group.

6. The water-absorbent material according to claim 1, wherein the compound B has a molecular weight of 1000 or less.

7. The water-absorbent material according to claim 1, wherein the compound B is an organic compound.

8. The water-absorbent material according to claim 7, wherein the compound B is at least one selected from the group consisting of glycerin, and polyglycerin having a molecular weight of 1000 or less.

9. The water-absorbent material according to claim 1, wherein the compound B is an inorganic compound.

10. The water-absorbent material according to claim 9, wherein the compound B is calcium chloride.

11. The water-absorbent material according to claim 1,
further comprising a matrix, wherein
the compound A and the compound B are dispersed in the matrix.

12. The water-absorbent material according to claim 11, wherein the matrix includes a hydrophilic polymer.

13. A water recovery device comprising the water-absorbent material according to claim 1.

14. A method for recovering water, the method comprising:
bringing the water-absorbent material according to claim 1 into contact with a gas or a liquid that contains water, to cause the water-absorbent material to take in water; and
applying stimulation from outside to the water-absorbent material, to take out liquid water from the water-absorbent material.
